(19) United States
(12) Patent Application Publication
(10) Pub. No.: US 2017/0142892 A1
(43) Pub. Date: May 25, 2017

(54) METHOD FOR SETTING A SPECIFIC DEGREE OF DRYING OF SEED STOCK IN DRESSING PROCESSES AND DEVICE THEREFOR

(71) Applicant: BAYER CROPSCIENCE AKTIENGESELLSCHAFT, DUESSELDORF (DE)

(72) Inventors: STEPHAN TOSCH, SPROCKHOEVEL (DE); LOTHAR SCHMIDT, KERPEN (DE); REINHARD GROSS, LEVERKUSEN (DE); GUIDO WENIG, LEVERKUSEN (DE); VOLKER MICHELE, KOELN (DE); CARSTEN CONZEN, LEVERKUSEN (DE)

(21) Appl. No.: 15/310,137

(22) PCT Filed: May 11, 2015
(86) PCT No.: PCT/EP2015/060365

§ 371 Date: Nov. 10, 2016

(30) Foreign Application Priority Data
May 12, 2014 (EP) 14167870.6

(51) Int. Cl. A01C 1/06

(52) U.S. Cl. CPC A01C 1/06

(57) ABSTRACT

The invention relates to a method with which in the dressing of seed stock the one specific degree of drying of the dressed seed stock can be set The invention also relates to a device with which the method according to the invention can be carried out, and to the use of this device.

The invention relates to a method with which it is possible during the dressing of seed stock to set the one specific degree of drying of the dressed seed stock. The invention also relates to a device with which the method according to the invention can be carried out, and to the use of this device.

For the dressing of seed stock, generally seeds, it is introduced into the tank of a dressing device, the dressing tank, and an aqueous dressing solution and/or suspension, also known for short as the dressing, is added, this tank or a part of the tank of the dressing device being moved, preferably rotated. The moving part of the tank may for example be the bottom of the tank. The movement of the dressing tank or tank part has the effect that the dressing is distributed uniformly over the individual seeds of the seed stock and remains adhering to them. Apart from water, among the ingredients contained in this dressing are agrochemical active substances, such as for example neonicotinoids, which are intended to have the effect that the seed stock and the plants growing from them are protected from pests and fungi. The dressing may also contain additives in a dissolved form or in the form of particles. These may be colourants, auxiliaries such as polymeric binders, mineral fillers and other additives. During the dressing, gas, with preference air, which may be at a higher temperature than the ambient air, that is to say may be preheated, is introduced into the tank of the dressing device in order to accelerate the drying of the dressing on the seed stock.

Dressing devices are known from the prior art, for example from DE4128258A1.

It is desired to end the dressing, including drying, i.e. the dressing process, as near as possible to when the dressed seed stock is of such a dryness that it is just pourable, that is to say that, under the respectively prevailing ambient conditions, such as temperature, relative atmospheric humidity and air pressure, the dressing no longer quite has the effect of making the seeds adhere to one another. If drying is continued beyond this degree of drying—the optimum degree of drying—on the one hand time and energy are wasted, on the other hand dust that contains active agrochemical substances is produced by the rubbing together of the dry, dressed seeds, and this dust can unwantedly get into the environment and cause damage there. It may however also be desired to set other degrees of drying as accurately as possible, for example in order to improve the resistance to abrasion during processing or the flow behaviour of the seed stock. These desired other degrees of drying—which may relate both to the degree of drying of the coating as a whole or to the degree of drying of the surface of the coating—are likewise referred to hereinafter as optimum degrees of drying.

It is known from the prior art that the dressing duration for the optimum degree of drying is determined empirically. In this case, the degree of drying and the pourability of the seed stock are determined after various dressing times and used to determine the optimum dressing time for a specific degree of drying. This method has the disadvantage that on the one hand it is complicated, due to the necessary preliminary tests, and on the other hand it is susceptible to errors, since the dressing duration is highly dependent on parameters that are variable and difficult to influence, such as the temperature of the seed stock and of the ambient air and also in particular the prevailing atmospheric humidity. This may have the effect that the dressing duration determined is too short or too long. In addition, even during the tests for determining the dressing duration, dust is unnecessarily produced.

It is also known from the prior art that the degree of drying of the seed stock during the dressing process is determined by connecting to the dressing device a dust measuring unit, which checks the progress of the drying in the dressing process on the basis of the production of dust and interrupts the dressing process when a specific amount of dust is produced. However, with this method the dressing process is often interrupted too late, since the development of dust must occur before the dressing process is interrupted.

It is also known from the prior art that the moisture of seed stock can be determined with the aid of capacitive, microwave, photometric or spectroscopic moisture measuring methods. These measuring methods have several disadvantages, including:
they make it necessary to install the measuring unit or at least essential parts thereof in the dressing device;
they do not allow direct measurement of the surface moisture, since the electromagnetic waves that are used for the measurement penetrate into the seed stock by several tenths of a millimetre to several millimetres, depending on the frequency; as a result, direct measurement of the surface properties of the dressed seed stock that are decisive for the rubbing is not possible;
previous dressing processes may have the effect that occupying the necessary measuring window, as it is known, which is used for this measuring method, may result in the measured value being influenced and the progress of the dressing and the end point being falsely given;
the seeds of the seed stock intrinsically vary in their moisture content from batch to batch, for example for reason of different provenance and storage or because different locations of a storage container may vary in dampness; this causes fluctuations from measurement to measurement, which can only be incompletely compensated even by sophisticated calibration.

The most accurate method known from the prior art for detecting the optimum degree of drying in dressing is for this degree of drying to be discerned by a skilled person from variation in the development or noise, that is to say also variation in the development of sound, during the dressing process. The different surface roughnesses of the dry undressed, moist dressed or dressed dried seed stock lead to a variation in the flow profile of the seed stock in the dressing device and to rubbing of the seeds against one another and against the wall. This is accompanied by variation in the development of sound caused by the movement of the seed stock in the dressing device during the dressing. For instance, this development of sound is drastically reduced if the dressing is initially added all at once and increases again during the drying. However, this method is on the one hand highly dependent on the hearing ability, the experience and the form on the day of this skilled person, and consequently poorly reproducible, on the other hand undeniably very personnel-intensive, and consequently cost-intensive.

The object of the present invention is to overcome the disadvantages of the prior art. In particular, the object of the present invention is to provide a device and a method with which the optimum degree of drying of the seed stock in a dressing process can be set.

The object is achieved by a dressing device with which in a dressing process the optimum degree of drying of the dressed seed stock can be set, comprising a measuring and controlling device, and by a method with which the optimum degree of drying of the seed stock in a dressing process can be set by using this measuring and controlling device.

Examples of the measuring and controlling device according to the invention—without restricting the invention to them—are:
a device comprising a unit for measuring the sound, in particular the sound level, that is caused by the dressing device and/or parts of this device and the seed stock contained in the dressing device;
a device comprising a unit for measuring the speed at which the seed stock moves when the tank or a part of the tank of the dressing device is moved; this measurement of the speed is with preference performed by means of radar waves;
a device comprising a unit for measuring the filling level of the seed stock, preferably at the tank wall;
a device comprising a unit for measuring the torque of the shaft that moves the tank or the moved part of the tank of the dressing device;
a device comprising a unit for measuring the effective power of the motor that moves the tank or the moved part of the tank of the dressing device;
a device comprising a unit for measuring the power consumption of the motor that moves the tank or the moved part of the tank of the dressing device.

Apart from the measuring unit, the measuring and controlling device also comprises at least a converter, which converts the value of the measured measuring variable (that is to say for example the sound, speed, filling level, torque, effective power or electrical power consumption) into an electrical or optical signal, an evaluation unit and a signal output. This signal output is connected to the dressing device, in particular its controller, in such way that, by outputting a corresponding signal from the signal output, the dressing process is interrupted. After that, the dressed seed stock can be removed from the dressing device. Alternatively, the seed stock may be subjected to a further dressing operation in the same dressing device, with a dressing of the same composition as in the previous dressing operation or with a dressing of a different composition than in the previous dressing operation, and/or is subjected to a further chemical and/or physical treatment.

Chosen according to the invention as the measuring variable is one that varies during the dressing process according to the degree of drying. It has thus been surprisingly found for example that
(a) the sound, in particular the sound level, that is caused by the dressing device and/or parts of this device and the seed stock contained in the dressing device,
(b) the speed with which the seed stock moves when the tank or the moved part of the tank of the dressing device is moved,
(c) the level to which the flow profile of the seed stock rises while it is being moved in the dressing device,
(d) the torque of the shaft that moves the tank or the moved part of the tank of the dressing device,
(e) the effective power of the motor that moves the tank or the moved part of the tank of the dressing device, and
(f) the electrical power consumption of the motor that moves the tank or the moved part of the tank of the dressing device,
   vary during the dressing process in dependence on the degree of drying of the seed stock in such a way that the degree of drying of the seed stock can thereby be determined sufficiently accurately to be able to set the optimum degree of drying. However, other measuring variables that are not expressly mentioned here may also be chosen, as long as they vary in dependence on the degree of drying of the seed stock in the dressing process in the same way or in an analogous way as the aforementioned measuring variables.

The dressing device may also have a number of measuring and controlling devices that measure the various measuring variables of which the value depends on the degree of drying of the seed stock during the dressing process.

With preference, the measuring and controlling device comprises an electroacoustic device. Such an electroacoustic device preferably comprises as the measuring unit a vibration pickup or an acceleration pickup, in particular a sound pickup. In the case of the electroacoustic device according to the invention, the measuring unit and the converter preferably form one unit in the form of a microphone, in particular a contact microphone.

The sound pickup is positioned such that it can pick up the sound that is caused by the seed stock located in the dressing device. Thus, with preference the sound pickup is attached to the dressing device, with particular preference on a part of the dressing device that is not moved, for example its outer wall. This has the advantage that the sound pickup is disturbed only little or not at all by sound or other vibrations or influences from the surroundings.

According to the invention, the sound pickup may also be positioned in the dressing tank. This has the advantage that the sound caused by the seed stock reaches the sound pickup with very high intensity.

According to the invention, the sound pickup may also be positioned in the vicinity of the dressing device. This has the advantage that no fastening to or in the dressing device has to be provided for the sound pickup.

Alternatively, the measuring and controlling device comprises one or more of the devices selected from the group of the following devices:
a device for measuring the speed with which the seed stock is moved when the tank or the moved part of the tank of the dressing device is moved, the speed measurement with preference taking place by means of radar waves,
a device for measuring the level to which the flow profile of the seed stock rises while it is being moved in the dressing device, this measurement with preference being performed optically,
a device for measuring the torque of the shaft that moves the tank or the moved part of the tank of the dressing device,
a device for measuring the effective power of the motor that moves the tank or the moved part of the tank of the dressing device,
a device for measuring the electrical power consumption of the motor that moves the tank or the moved part of the tank of the dressing device.

The invention also concerns a method for setting the optimum degree of drying of seed stock in dressing processes. In the case of the method according to the invention, the optimum degree of drying of the seed stock is determined continuously by means of a measuring and controlling device connected to the dressing device on the basis of the measurement of a measuring variable of which the value varies according to the degree of drying in the dressing process. The optimum degree of drying is thereby determined and the dressing process is interrupted when this optimum degree of drying is reached. In this case, “continuously” means in connection with the measuring and controlling device that an operation takes place at least once every five seconds, with preference at least once every three seconds, with particular preference at least once a second and with most particular preference several times a second, in particular five to ten times a second.

The evaluation unit of the measuring and controlling device measures the measuring variable continuously and additionally has an algorithm that continuously evaluates the time-dependent variation in the measuring variable. The algorithm is started at the latest when the entire seed stock has been fed into the dressing tank, the latter is moving and the other devices of the dressing device, for example the motor and the air injection, have also been put into operation. The algorithm preferably also determines the then prevailing average value of the measuring variable and determines it is a basic value for the determination of the optimum degree of drying, in particular if the sound, in particular the sound level, the speed at which the seed stock moves when the tank or the moved part of the tank of the dressing device is moved, or the level to which the flow profile of the seed stock rises while it is being moved in the dressing device has been chosen as the measuring variable. Preferably, the average fluctuation of the value of the measuring variable is thereby also determined. When the dressing is added, the value of the measuring variable changes sharply.

Thus, for example, when measuring
(a) the sound, in particular the sound level, that is caused by the dressing device and/or parts of this device and the seed stock contained in the dressing device,
(b) the speed with which the seed stock moves when the tank or the moved part of the tank of the dressing device is moved,
(c) the level to which the flow profile of the seed stock rises while it is being moved in the dressing device,
   the value of the measuring variable falls sharply. The algorithm also determines, for example by comparison of the values of a specific measured value of the measuring variable with the values of the previous values of the measuring variable or by means of the first derivative of the smoothed curve of the measuring variable over time, the minimum value of the measuring variable after adding the dressing. Serving as the smoothed curve in the sense of this application may be for example a curve in the case of which one point of this curve represents the mean value of the N previous points, where N is a positive whole number in the range from 2 to 10, with preference in the range from 3 to 7, and with particular preference is 5. With increasing drying of the seed stock, the value of the measuring variable increases again. When a value of the measuring variable that corresponds to a specific proportion Q of the difference between the average value of the measuring variable before the adding of the dressing and the minimum value of the measuring variable after the adding of the dressing that is greater than the minimum sound level after the adding of the dressing is reached, the optimum degree of drying is reached. The algorithm then generates a signal by which the dressing process is interrupted via the signal output of the evaluation unit.

Instead of a measuring variable itself, its 1st or 2nd derivative may also be determined. With the values obtained therefrom—if necessary after mathematical transformation—the same procedure as with the values of a measuring variable is followed within the scope of the present invention, in other words there is no distinction between the two.

Q is determined by calibration. Q is for example dependent on the dressing device, the type of seed stock, the type of dressing, the measuring variable chosen, the degree of drying that is regarded as the optimum degree of drying, and whether the degree of drying relates to the coating as a whole or only to the surface of the coating. Q preferably lies in the range from 20 to 60%, with preference in the range from 30 to 50%, with particular preference in the range from 35 to 45%. For the case where the degree of drying with which the seed stock is just pourable is desired as the optimum degree of drying, Q for the aforementioned measuring variables (1) to (3) is approximately 40%.

To sum up, the algorithm works as follows in the case of the measuring variables (a) to (c):
(i) determination of the average value of the measuring variable of the dressing device in operation after adding of the seed stock but before adding the dressing.
(ii) determination of the minimum value of the measuring variable after adding the dressing to the seed stock located in the dressing device in operation.
(iii) determination of a value of the measuring variable that corresponds to a certain proportion Q of the difference between the average value of the measuring variable before the adding of the dressing and the minimum value of the measuring variable after the adding of the dressing that is greater than the minimum value of the measuring variable after the adding of the dressing.
(iv) output of the signal for interrupting the dressing process when the value of the measuring variable in accordance with (iii) is reached.

The output of the signal for interrupting the dressing process when the value of the measuring variable in accordance with (iii) is reached preferably has the effect that the dressing process is interrupted. After that, the dressed seed stock can be removed from the dressing device. Alternatively, the seed stock may be subjected to a further dressing operation in the same dressing device, with a dressing of the same composition as in the previous dressing operation or with a dressing of a different composition than in the previous dressing operation, and/or is subjected to a further chemical and/or physical treatment.

The point in time of the adding of the dressing may be transmitted to the measuring and controlling device by manual input, for example by pressing a button, by a signal of the controller of the dressing device to the measuring and controlling device, for example if the dressing is added by the dressing device automatically, or by an algorithm of the measuring and controlling device itself. This algorithm may for example work in such a way that, apart from the average value of the measuring variable after complete adding of the seed stock, the average fluctuation of the measuring variable before feeding in of the dressing is also determined. When adding the dressing, the value of the measuring variable falls by an amount that is greater than two times, with preference than three times, with particular preference than four times, with most particular preference than five times, the average fluctuation of the measuring variable before adding of the dressing. When the falling by this amount is reached, the algorithm interprets this as the adding of the dressing. As from the adding of the dressing, irrespective of how the measuring and controlling device requires this information, the algorithm determines the minimum value of the measuring variable after adding of the dressing. Alternatively, for determining the point in time of the adding of the dressing, the algorithm may work in such a way that it regards the absolute minimum of the first derivative of the smoothed curve of the measured value over time as being this point in time.

Consequently, the method for setting a specific degree of drying of seed stock in dressing processes comprises the following steps when (a) the sound, in particular the sound level, that is caused by the dressing device and/or parts of this device and the seed stock contained in the dressing device, (b) the speed with which the seed stock moves when the tank or the moved part of the tank of the dressing device is moved, (c) the level to which the flow profile of the seed stock rises while it is being moved in the dressing device or a measuring variable that behaves in a way analogous to the aforementioned measuring variables during the dressing process is used as the measuring variable:
(I) measurement of the measuring variable and determination of the average measuring variable of the dressing device in operation after adding the seed stock but before adding the dressing;
(II) measurement of the measuring variable and determination of the minimum measuring variable after adding the dressing to the seed stock located in the dressing device in operation;
(III) determination of the value of a measuring variable that corresponds to a certain proportion Q of the difference between the average value of the measuring variable before the adding of the dressing and the minimum measuring variable after the adding of the dressing that is greater than the minimum measuring variable after the adding of the dressing;
(IV) output of the signal for interrupting the dressing process when the sound level in accordance with (III) is reached;
(V) interruption of the dressing process.

Preferably, the sound, in particular the sound level, is chosen as the measuring variable.

Alternatively, the variation over time of the sound curve is used for determining the end point (1st mathematical derivative), in order to determine a threshold value for the switch-off. After adding of the dressing, a time t1 after the minimum of the 1st derivative is sought, this minimum being greater than two times, with preference than three times, with particular preference than four times, with most particular preference than five times, the average fluctuation of the first derivative of the measuring variable before adding of the dressing. The temporally associated sound value is defined as the threshold value for the end point. This may be weighted by means of the factor F in order to initiate an earlier or later switch-off. After a time t2, the threshold value is compared with the sound value at the particular time. The factor f is usually determined empirically, in order to adapt the algorithm optimally to a specific combination of dressing unit, seed stock and dressing solution. F typically assumes values in the range between 0.7 and 1.3, but may well also assume values in the range between 0.5 at 1.5. In an individual case, more extreme values are also possible in order to conduct the process optimally. If a factor F is determined, according to the invention the threshold value is corrected by multiplication by F.

The optimum end point is reached when the sound value is equal to or greater than the threshold value. The threshold value is newly determined each time the process is started. The algorithm may be used without any adaptations for different dressing units.

To sum up, the algorithm works as follows for the measuring variables (a) to (c):
(i) determination of the minimum average value of the time derivative of the sound, in particular the sound level of the dressing device in operation determined after complete adding of the seed stock and the dressing;
(ii) establishment of the threshold value of the sound value that is the sound value associated with the minimum of the sound value from (i);
(iii) measurement of the sound value and comparison of this value with the threshold value until the measured sound value is equal to or greater than the threshold value;
(iv) output of the signal for interrupting the dressing process when the value of the measuring variable in accordance with (iii) is reached;
This algorithm is advantageous in particular whenever the determination of the value Q from the methods presented above is difficult. This may for example by dependent on the dressing apparatus used, the seed stock used or the dressing solution used.

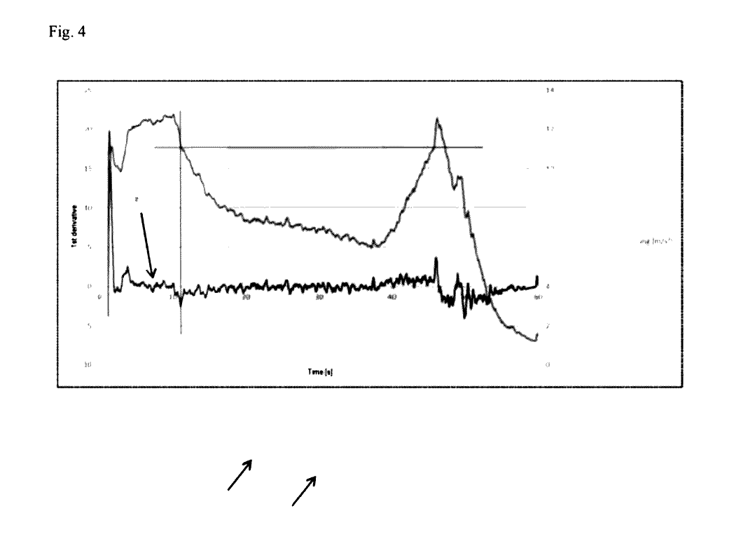

This algorithm is described by way of example in FIG. 4.

By contrast with the sound that is caused by the dressing device and/or parts of this device and the seed stock contained in the dressing device, the speed at which the seed stock moves when the tank or the moved part of the tank of the dressing device is moved and the level to which the flow profile of the seed stock rises while it is being moved in the dressing device, when measuring for example
(d) the torque of the shaft that moves the tank or the moved part of the tank of the dressing device,
(e) the effective power of the motor that moves the thank or the moved part of the tank of the dressing device, and
(f) the electrical power consumption of the motor that moves the tank or the moved part of the tank of the dressing device,
   the measuring variable increases sharply when the dressing is added. After that, as drying progresses, a further rise in the measuring variable can be noted, but this rise is initially smaller than immediately after the adding of the dressing. Only when the drying is well advanced does the measuring variable increase sharply again. In the cases (d) to (f), the algorithm preferably evaluates the first derivative of the smoothed curve. The point in time of the adding of the dressing may in this case by transmitted to the measuring and controlling device by manual input, for example by pressing a button, by a signal of the controller of the dressing device to the measuring and controlling device, for example if the dressing is added by the dressing device automatically, or by an algorithm of the measuring and controlling device itself. This algorithm may for example work in such a way that it determines the first derivative of the smoothed curve of the measuring variable over time. The point in time of the adding of the dressing is then determined by a first maximum of the first derivative after complete adding of the seed stock, this maximum being greater than two times, with preference than three times, with particular preference than four times, with most particular preference than five times, the average fluctuation of the first derivative of the measuring variable before adding of the dressing. If this first maximum after complete adding of the seed stock is determined, the algorithm interprets this as the adding of the dressing. After reaching this first maximum, the values of the first derivative of the smoothed curve of the measuring variable over time fall again, but remain higher than the values before adding of the dressing. When drying is well advanced, the values of the first derivative of the smoothed curve of the measuring variable over time increase again and form a second maximum after complete adding of the seed stock. When the second maximum is reached, the optimum degree of drying is reached.

To sum up, the algorithm works as follows for the measuring variables (d) to (f):
(i) determination of the values of the first derivative of the smoothed curve of the values of the measuring variable over time of the dressing device in operation after adding of the seed stock but before adding of the dressing;
(ii) recording of the point in time of the adding of the dressing, for example by manual input, by a signal of the controller of the dressing device to the measuring and controlling device, for example if the dressing is added by the dressing device automatically, or by determination of the first maximum of the values of the first derivative of the smoothed curve of the values of the measuring variable over time after complete adding of the seed stock;
(iii) determination of the second maximum of the values of the first derivative of the smoothed curve of the values of the measuring variable over time after complete adding of the seed stock;
(iv) output of the signal for interrupting the dressing process when the second maximum in accordance with (iii) is determined.

The output of the signal for interrupting the dressing process preferably has the effect that the dressing process is interrupted, alternatively is continued for a fixed or variable time and then interrupted. After that, the dressed seed stock can be removed from the dressing device. Alternatively, the seed stock may be subjected to a further dressing operation in the same dressing device, with a dressing of the same composition as in the previous dressing operation or with a dressing of a different composition than in the previous dressing operation, and/or is subjected to a further chemical and/or physical treatment.

Consequently, the method for setting a specific degree of drying of seed stock in dressing processes comprises the following steps when (4) the torque of the shaft that moves the tank or the moved part of the tank of the dressing device, (5) the effective power of the motor that moves the tank or the moved part of the tank of the dressing device, (6) the electrical power consumption of the motor that moves the tank or the moved part of the tank of the dressing device, or a measuring variable that behaves in a way analogous to the aforementioned measuring variables during the dressing process is used as the measuring variable:
(I) determination of the values of the first derivative of the smoothed curve of the values of the measuring variable over time of the dressing device in operation after adding of the seed stock but before adding of the dressing;
(II) recording of the point in time of the adding of the dressing, for example by manual input, by a signal of the controller of the dressing device to the measuring and controlling device, for example if the dressing is added by the dressing device automatically, or by determination of the first maximum of the values of the first derivative of the smoothed curve of the values of the measuring variable over time after complete adding of the seed stock;
(III) determination of the second maximum of the values of the first derivative of the smoothed curve of the values of the measuring variable over time after complete adding of the seed stock;
(IV) output of the signal for interrupting the dressing process when the second maximum in accordance with (III) is reached;
(V) interruption of the dressing process.

Preferably, the effective power is used as the measuring variable.

This invention also concerns the use of the dressing device according to the invention and the method according to the invention for setting the optimum degree of drying of seed stock. For this purpose, the method according to the invention that is described above for setting the optimum degree of drying of seed stock in dressing processes is carried out with the dressing device according to the invention.

The following exemplary embodiments, drawings and diagrams are intended to illustrate the invention, without it being restricted to them.

### EXAMPLE 1

### Dressing Experiment With Measurement of the Sound Level and With Determination of a Threshold Value (Minimum First Derivative of the Sound Level)

Seed Stock Treatment with a CBT25

1st Step: Idling
During idling, there was not yet any seed stock in the dressing hopper. The motor was running at a constant rotation speed. There was little vibration, and so there was very little structure-borne sound.

2nd Step: Loading With Seed Stock
Maize seed stock was fed into the rotating mixing hopper via a silo or by hand. There was a strong increase in the signal of the vibration sensor. The greater the drop height, the greater the amplitude of the vibration sensor. There may be a delayed maximum amplitude if the motor does not reach the maximum rotational speed directly or is slowed down severely by the loading. The highest sound amplitude is expected during the loading.

3rd Step: Adding of Suspension/Dressing
With the beginning of the adding of the suspension, a significant drop in the structure-borne sound was measured. The point in time of the adding of the dressing was used as a starting parameter for the later processing in the evaluation algorithms.

4th Step: Drying
As soon as the suspension had mixed homogeneously with the seed stock, an approximately constant measuring signal was displayed. The dressing began to dry on the surface of the seed stock, whereby an increase in the structure-borne sound was measured.

5th Step: Discharge of the Seed Stock/Belated Discharge
The discharge of the seed stock again produced a high structure-borne sound. For this reason, a short sharp increase was discernible. As the drying increasingly progressed, a reduction again in the measured value was observed.

The variation of the sound level is shown in FIG. 4.

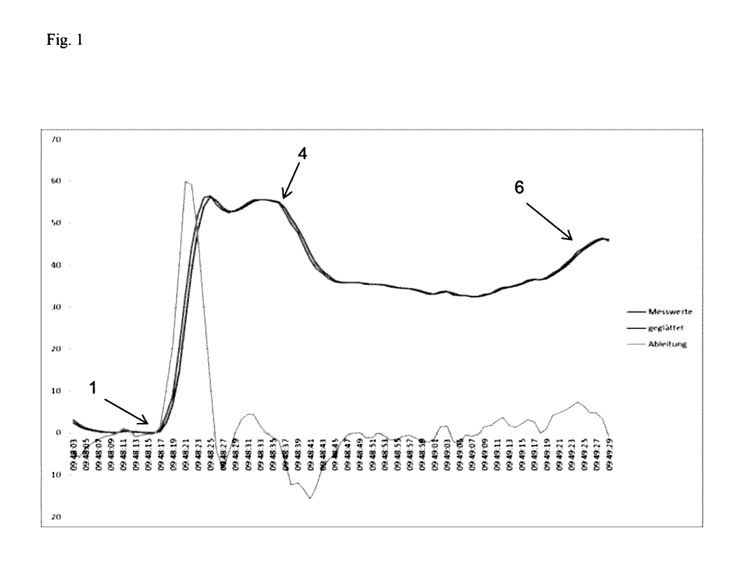

FIG. 1 shows a diagram in which the variation (3) of the measured values of the sound level in m/s² over time when dressing seed stock is represented. It can be clearly seen that the sound level increases sharply in a short time when feeding in the stock (1) and then remains at approximately the same level. When adding the dressing (4), the sound level then falls sharply in a short time and remains at approximately the same level for a relatively long time before it increases again with increasing drying of the seed stock.

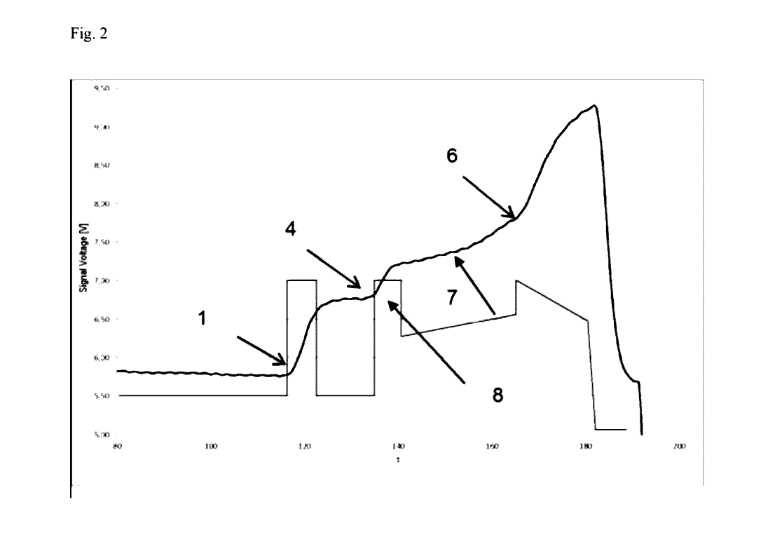

FIG. 2 shows a diagram in which the variation (7) of the measured values of the effective power, indicated by a signal voltage in volts [V], over time is represented. It can be clearly seen that the measuring variable increases sharply in a short time when feeding in the seed stock (1) and then remains at approximately the same level. When adding the dressing (4), the effective power then increases sharply again, to increase further only little then as drying progresses. Only when drying has progressed considerably does the measuring variable increase sharply again.

In FIG. 1 and FIG. 2, the designations have the following meaning:
1 point in time of feeding in the seed stock
2 1st derivative of the smoothed curve of the variation in the measured values of the sound level over time
3 variation in the measured values of the sound level over time
4 point in time of the adding of the dressing
5 smoothed curve of the variation in the measured values of the sound level over time
6 point in time at which optimum drying is reached
7 variation of the measured values of the effective power over time
8 first maximum of the 1st derivative of the smoothed curve of the variation of the measured values of the effective power over time after complete adding of the seed stock, schematic representation

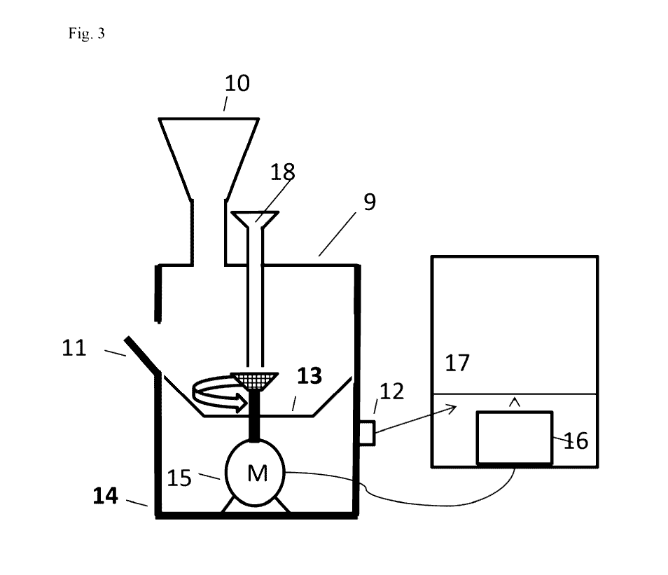

FIG. 3 shows a dressing device according to the invention. This comprises:
9 dressing apparatus
10 feeding opening for seed stock
11 outlet opening
12 sound pickup
13 rotating part of the apparatus
14 static part of the apparatus
15 motor
16 power pickup
17 evaluation and control unit
18 feeding opening for dressing

FIG. 4 shows the measurement of the sound level and the evaluation according to Example 1
1 acceleration in m/s² from piezoelectric sensor (sound value)
2 1st derivative of the smoothed curve of the variation of the measured values of the sound level over time
3 threshold value of the sound curve

1. A dressing device for a dressing process wherein the degree of drying of dressed seed stock and an optimum degree of drying can be set, comprising a measuring and controlling device, wherein the measuring and controlling device measures a measuring variable, the value thereof depending on the degree of drying of the seed stock during a dressing process.

2. A dressing device according to claim 1, wherein the measuring variable is selected from:
(a) sound that is caused by the dressing device and/or parts of said device and the seed stock contained in the dressing device,
(b) speed with which the seed stock moves when a tank or a moved part of the tank of the dressing device is moved,
(c) level to which the flow profile of the seed stock rises while being moved in the dressing device,
(d) torque of a shaft that moves a tank or part of a tank of the dressing device, and
(e) effective power of a motor that moves a tank or a moved part of a tank of the dressing device,
(f) electrical power consumption of a motor that moves a tank or a moved part of a tank of a dressing device,
or the measuring variable is one that varies in dependence on the degree of drying of the seed stock in the dressing process in the same way or in an analogous way as the measuring variables (a) sound, (b) speed, (c) level of rise of the flow profile, (d) torque of the shaft, (e) effective power of the motor or (f) electrical power consumption of the motor.

3. A dressing device according to claim 1, wherein the measuring and controlling device comprises a converter, which converts the value of the measured measuring variable into an electrical or optical signal, an evaluation unit and a signal output.

4. A dressing device according to claim 3, wherein the measuring and controlling device is connected to the dressing device in such way that, by outputting a corresponding signal from the signal output, the dressing process is interrupted.

5. A method for setting a specific degree of drying of seed stock in a dressing process comprising:
(I) measurement of a measuring variable and determination of an average measuring variable of a dressing device in operation after adding seed stock but before adding dressing;
(II) measurement of a measuring variable and determination of a minimum measuring variable after adding a dressing to seed stock located in a dressing device in operation;
(III) determination of a measuring variable that corresponds to a certain proportion Q of the difference between the average measuring variable before the adding of a dressing and a minimum measuring variable after adding of the dressing that is greater than the minimum measuring variable after the adding of the dressing;
(IV) output of a signal for interrupting the dressing process when the sound level in accordance with (III) is reached;
(V) interruption of the dressing process,
the measuring variable being selected from:
(a) sound that is caused by the dressing device and/or parts of said device and the seed stock contained in the dressing device,
(b) speed with which the seed stock is moved when a tank or a moved part of a tank of the dressing device is moved, and
(c) level to which a flow profile of the seed stock rises while being moved in the dressing device,
or the measuring variable is one that varies in dependence on the degree of drying of the seed stock in the dressing process in the same way or in an analogous way as the measuring variables (a) sound, (b) speed or (c) level of rise of the flow profile.

6. The method according to claim 5, wherein the proportion Q lies in the range from 10 to 80%, optionally in the range from 20 to 60%, optionally in the range from 30 to 50%, optionally in the range from 35 to 45%.

7. The method for setting a specific degree of drying of seed stock in a dressing process comprising:
(I) determination of values of a first derivative of a smoothed curve of values of a measuring variable over time of a dressing device in operation after adding of seed stock but before adding a dressing;
(II) recording of a point in time of adding of the dressing, optionally by manual input, by a signal of the controller of the dressing device to the measuring and controlling device, optionally if the dressing is added by the dressing device automatically, or by determination of a first maximum of values of the first derivative of the smoothed curve of values of a measuring variable over time after complete adding of seed stock;
(III) determination of a second maximum of values of a first derivative of a smoothed curve of values of a measuring variable over time after complete adding of the seed stock;
(IV) output of a signal for interrupting the dressing process when the second maximum in accordance with (III) is reached;
(V) interruption of the dressing process,
the measuring variable being selected from:
(d) torque of a shaft that moves a tank or a moved part of a tank of the dressing device,
(e) effective power of a motor that moves a tank or a moved part of a tank of the dressing device, and
(f) electrical power consumption of a motor that moves a tank or a moved part of a tank of a dressing device,
or the measuring variable is one that varies in dependence on the degree of drying of the seed stock in the dressing process in the same way or in an analogous way as the measuring variables (d) torque of the shaft, (e) effective power of the motor or (f) electrical power consumption of the motor.

8. A method for setting a specific degree of drying of seed stock in a dressing process comprising:
(i) determination of a minimum average value of a time derivative of a sound, optionally a sound level of a dressing device in operation determined after complete adding of a seed stock and a dressing;
(ii) establishment of a threshold value of a sound value that is a sound value associated with a minimum of the sound value from (i);
(iii) measurement of a sound value and comparison thereof with a threshold value until a measured sound value is equal to or greater than the threshold value;
(iv) output of a signal for interrupting the dressing process when the value of the measuring variable in accordance with (iii) is reached.

9. The method according to claim 5, wherein after the interruption of the dressing process, the seed stock is removed from the dressing device.

10. The method according to claim 5, wherein after the interruption of the dressing process, the seed stock is subjected to a further dressing operation in the same dressing device, with a dressing of the same composition as in the previous dressing operation or with a dressing of a different composition than in the previous dressing operation, and/or is subjected to a further chemical and/or physical treatment.

11. A device according to claim 1 for setting the optimum degree of drying of seed stock in a dressing process.

12. A process for dressing seed stock comprising using a dressing device according to claim 1.
